(19) United States
(12) Patent Application Publication
(10) Pub. No.: US 2014/0143882 A1
(43) Pub. Date: May 22, 2014

(54) SYSTEMS AND METHODS FOR PRESERVING PRIVACY FOR WEB APPLICATIONS

(71) Applicants: Iraj Saniee, New Providence, NJ (US); Christopher A. White, Neshanic Station, NJ (US); William S. Kennedy, Summit, NJ (US)

(72) Inventors: Iraj Saniee, New Providence, NJ (US); Christopher A. White, Neshanic Station, NJ (US); William S. Kennedy, Summit, NJ (US)

(73) Assignee: Alcatel-Lucent USA Inc., Murray Hill, NJ (US)

(21) Appl. No.: 13/683,069

(22) Filed: Nov. 21, 2012

(51) Int. Cl. G06F 21/60

(52) U.S. Cl. CPC G06F 21/60
USPC 726/26

(57) ABSTRACT

A system and method for preserving privacy includes selecting a plurality of lexicons and executing a plurality of random operations through at least one web application using the plurality of lexicons. The system and method models the plurality of random operations based on typical usage to mask actual operations or searches executed by a user.

### FIELD OF THE INVENTION

The present invention relates to web applications.

### BACKGROUND OF THE INVENTION

Increased use of web applications through browsers over networks, such as the World Wide Web, has provided marketing companies with increased access to personal information about users through data mining techniques and the like. Although the increased access to personal information allows the marketing companies to strategically target their marketing efforts to particular interests of the users, the strategic targeting comes at the cost of the users' privacy.

### SUMMARY

According to an embodiment, a computerized system for preserving privacy comprises a selection module adapted to select a plurality of lexicons and a privacy-preserving module adapted to execute a plurality of random operations using the plurality of lexicons.

According to an embodiment, the computerized system for preserving privacy may include at least one data storage device storing the selection module and the privacy-preserving module. The computerized system may further include at least one processor configured to implement the selection module and the privacy-preserving module.

According to an embodiment, the selection module may include a graphical user interface.

According to an embodiment, the graphical user interface may include at least one input allowing selection of the plurality of lexicons.

According to an embodiment, the computerized system may comprise a database for storing terminology from which the plurality of lexicons may be selected.

According to an embodiment, the selection module may include a data-mining module adapted to determine a typical usage pattern of the at least one web application by a unique user.

According to an embodiment, the privacy-preserving module may execute the plurality of random operations using the plurality of lexicons and the typical usage pattern.

According to an embodiment, the data-mining module may be adapted to determine web application data including a typical usage of the web application by others and/or a current topic of interest on the at least one web application.

According to an embodiment, the privacy-preserving module may execute the plurality of random operations using the web application data.

According to an embodiment, a computerized method for preserving privacy comprises the steps of selecting, by a selection module executing on a computer processor, a plurality of lexicons and executing, by a privacy-preserving module executing on the computer processor, a plurality of random operations though at least one web application using the plurality of lexicons.

According to an embodiment, the computerized method may also comprise the step of determining, by the selection module executing on the computer processor, a typical usage pattern of the at least one web application by a user.

According to an embodiment, the computerized method may also comprise the step of generating, by the selection module executing on the computer processor, a graphical user interface.

According to an embodiment, the step of selecting, by the selection module executing on the computer processor, a plurality of lexicons may include accessing stored terminology in a database.

According to an embodiment, accessing the stored terminology in the database may include selecting the plurality of lexicons based on a specified discipline.

According to an embodiment, the computerized method may also comprise the step of determining, by the selection module executing on the computer processor, web application data including at least one of a typical usage of the web application by others and a current topic of interest on the at least one web application.

According to an embodiment, a non-transitory, tangible computer-readable medium storing instructions adapted to be executed by a computer processor to perform a method for preserving privacy may comprise the steps of selecting, by a selection module executing on a computer processor, a plurality of lexicons and executing, by a privacy-preserving module executing on the computer processor, a plurality of random operations though at least one web application using the plurality of lexicons.

According to an embodiment, the method may further comprise the step of determining, by the selection module executing on the computer processor, a typical usage pattern of the at least one web application by a user.

According to an embodiment, the step of selecting, by the selection module executing on the computer processor, a plurality of lexicons may include accessing stored terminology in a database.

According to an embodiment, accessing the stored terminology in the database may include selecting the plurality of lexicons based on a specified discipline.

According to an embodiment, the method may further comprise the step of determining, by the selection module executing on the computer processor, web application data including at least one of a typical usage of the web application by others and a current topic of interest on the at least one web application.

These and other embodiments of will become apparent in light of the following detailed description herein, with reference to the accompanying drawings.

### BRIEF DESCRIPTION OF THE DRAWINGS

FIG. 1 is a schematic diagram of a computerized system according to an embodiment;

FIG. 2 is a flow diagram of an embodiment for privacy preservation through the computerized system of FIG. 1; and

FIG. 3 is a schematic diagram of an embodiment of the computerized system of FIG. 1.

### DETAILED DESCRIPTION

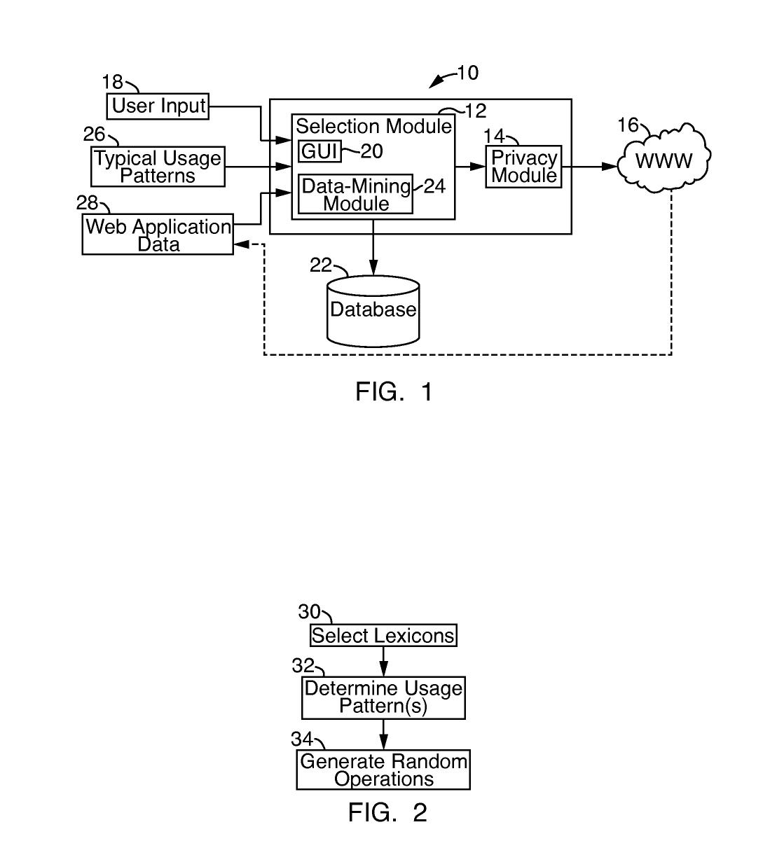

Referring to FIG. 1, an embodiment of a computerized system 10 for preserving privacy is shown. The computerized system 10 includes a selection module 12 and a privacy-preserving module 14. The selection module 12 is adapted to select a plurality of lexicons and to provide the plurality of lexicons to the privacy-preserving module 14. The term lexicons, as used herein, refers to any words, terms, phrases, topics, numbers, symbols, World Wide Web domains or the like that may be used as input for a web application. The privacy-preserving module 14 is adapted to execute a plurality of random operations on the World Wide Web 16 through at least one web application using the selected lexicons. The plurality of random operations may include, for example, queries, searches, postings, submissions, endorsements or any similar tasks performed through web applications.

The at least one web application may be an application that is accessed by users over a network such as the World Wide Web or an application that is coded in a browser-supported language (e.g. JavaScript, HTML or the like) and executable through a web browser. Exemplary web applications may include, for example, Facebook, Twitter, Linkedin, various Google searches, Hulu, Groupon, or the like.

The lexicons may be selected through the selection module 12 in a variety of different ways. For instance, the selection module 12 may allow the user to manually input lexicons through a user input 18. The user input 18 may include, for example, a graphical user interface (GUI) 20 that allows the user to simply enter a variety of different terminology as the lexicons. The selection module 12 provides the lexicons to the privacy-preserving module 14 to be used as input for the plurality of random operations, as discussed below. The section module 12 may also store the lexicons entered through the user input 18 in a database 22 for use in future random operations.

The user input 18 may allow the user to select lexicons that include terms or specific World Wide Web domains to search that will exhibit a desired persona to any marketing companies using data mining techniques to access personal information of World Wide Web users. For example, the user could input lexicons that include terms and/or domains related to fitness (e.g. training, healthy, exercise, workout, etc.) to exhibit the persona of a person with a healthy lifestyle. Similarly, by inputting desired lexicons through the user input 18, the user may exhibit a desired occupation, area of expertise, political interest, hobby, etc.

In an embodiment, the user input 18 may also allow the user to enter a single term, which the selection module 12 uses to populate a variety of lexicons from related terms stored in the database 22. For instance, the user may input the term “medicine” through the user input 18 so that the selection module 12 populates a variety of lexicons related to medical terminology. The single term may be input through the GUI 20 in a text field, selected from a dropdown menu of available topics or the like. The user input 18 allows the user to define a plurality of topic or discipline specific lexicons by simply selecting the topic or discipline through the GUI 20.

The user input 18 may also allow the user to enter timing and frequency parameters defining when and how often the privacy-preserving module 14 executes the random operations. For instance, the user input 18 may allow the user to specify the frequency at which the random operations are executed, certain hours of the day in which the random operations are executed and/or other similar timing and frequency constraints.

The selection module 12 may include a data-mining module 24 that monitoring the user's computer system to obtain the user's typical usage patterns 26 of various web applications. The data-mining module 24 may use known monitoring and analysis data mining techniques to obtain information relating to specific web applications that the user uses, the frequency at which the user uses each of the web applications, the typical times of day that the user uses each of the web applications and/or other similar timing and use information. The privacy-preserving module 14 may use these typical usage patterns 26 of the user when executing the random operations so that the random operations are modeled after the unique user's typical use, thereby masking the actual operations conducted by the user through the web applications, as will be discussed in greater detail below.

The data-mining module 24 may also mine data from the various web applications using known monitoring and analysis data mining techniques to obtain web application data 28 for use as the lexicons. The web application data 28 may include, for example, current topics of interest to the online community, current news topics, current and/or local topics trending on the various web applications, for example, Twitter, Google, Facebook or the like, and any other similar data.

As discussed above, the privacy-preserving module 14 uses the lexicons and usage patterns defined by the selection module 12 to execute the plurality of random operations. The privacy-preserving module 14 models the frequency and timing of the random operations of the plurality of random operations after the user's typical usage patterns 26 and/or usage patterns of the web applications derived from the web application data 28. The privacy-preserving module 14 uses the lexicons provided by the selection module 12 to define the content of the random operations so that the random operations are based on discipline-specific vocabulary selected by the user, topics of current interest to the online community and/or indicative of a desired persona that the user wishes to publically express. The random operations of the plurality of random operations executed by the privacy-preserving module 14 are generated in addition to any specific network operations or queries executed by the user. Thus, the privacy-preserving module 14 dilutes the specific operations or queries executed by the user with a large number of content-customized but otherwise random operations and/or searches that are indistinguishable from the expected activity or search pattern of the user. Additionally, the privacy-preserving module 14 may also follow one or more web links that arise from the resulting random operations to obfuscate not only the search habits, but also the browsing habits of the user.

The plurality of random operations generated by the privacy-preserving module 14 results in less specific information being made available about the user or, in the case of a user wishing to exhibit a desired persona, information within a limited number of selected domains and/or topics. For example, if the user is searching the World Wide Web for information on a particular medical procedure using a web search application, the privacy-preserving module 14 may executed the plurality of random operations, e.g. generate a plurality of random web searches, using medical terms as the lexicons to mask the actual search being executed by the user. Thus, the computerized system 10 prevents marketing or other companies from obtaining personal information about the user through data mining techniques and the like.

Referring to FIG. 2, in operation, to preserve the user's privacy, the computerized system 10, shown in FIG. 1, first selects lexicons at 30 through the selection module 12, shown in FIG. 1, for use in the plurality of random operations as discussed above. The selection module 12, shown in FIG. 1, also determines one or more usage patterns with which to model the plurality of random operations after at 32, as discussed above. The privacy-preserving module 14, shown in FIG. 1, uses the lexicons selected at 30 and the usage patterns determined at 32 to execute the plurality of random operations on the World Wide Web 16, shown in FIG. 1, through at least one web application at 34.

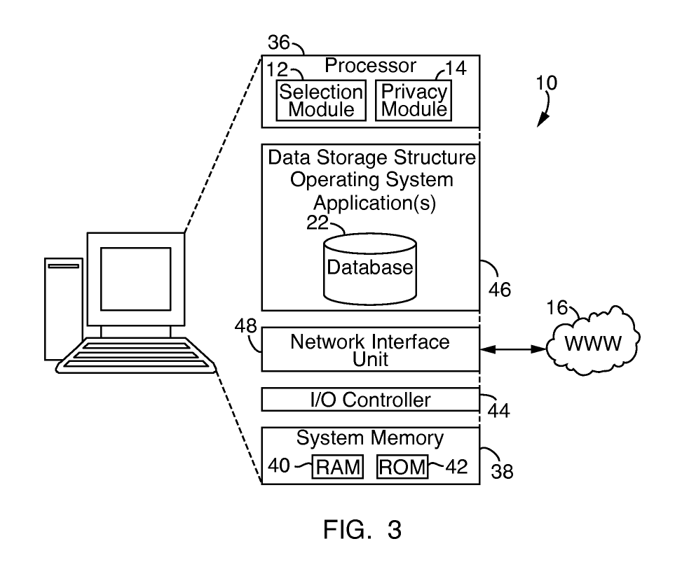

Referring to FIG. 3, an exemplary embodiment of the computerized system 10 is shown. The computerized system 10 has the necessary electronics, software, memory, storage, databases, firmware, logic/state machines, microprocessors, communication links, displays or other visual or audio user interfaces, printing devices, and any other input/output interfaces to perform the functions described herein and/or to achieve the results described herein. For example, the computerized system 10 may include at least one processor 36, system memory 38, including random access memory (RAM) 40 and read-only memory (ROM) 42, an input/output controller 44, and one or more data storage structures 46. The computerized system 10 is connected to the World Wide Web 16 through a network interface unit 48. All of these latter elements are in communication with the at least one processor 36 to facilitate the operation of the computerized system 10 as discussed below. Suitable computer program code may be provided for executing numerous functions, including those discussed below in connection with the selection module 12 and privacy-preserving module 14. The computer program code may also include program elements such as an operating system, a database management system and “device drivers” that allow the processor 36 to interface with computer peripheral devices (e.g., a video display, a keyboard, a computer mouse, etc.) via the input/output controller 44.

The at least one processor 36 may include one or more conventional microprocessors and one or more supplementary co-processors such as math co-processors or the like. The processor 36 is in communication with the network interface unit 48, through which the processor 36 may allow a user to access and/or execute one or more web applications, such as Facebook, Twitter, Linkedin, various Google searches, Hulu, Groupon, or the like. The network interface unit 48 may include multiple communication channels for simultaneous communication with, for example, other processors, servers or operators. Devices in communication with each other need not be continually transmitting to each other. On the contrary, such devices need transmit to each other as necessary, may actually refrain from exchanging data most of the time, and may require several steps to be performed to establish a communication link between the devices.

The at least one processor 36 is in communication with the one or more data storage structures 46. The data storage structures 46 may comprise an appropriate combination of magnetic, optical and/or semiconductor memory, and may include, for example, RAM, ROM, flash drive, an optical disc such as a compact disc and/or a hard disk or drive. The at least one processor 36 and the one or more data storage structures 46 each may be, for example, located entirely within a single computer or other computing device; or connected to each other by a communication medium, such as a USB port, serial port cable, a coaxial cable, an Ethernet type cable, a telephone line, a radio frequency transceiver or other similar wireless or wired medium or combination of the foregoing. For example, the processor 36 may be connected to the data storage structure 46 via the network interface unit 48.

The data storage structure 46 may store, for example, one or more databases 22 adapted to store information that may be utilized to store information required by the program, an operating system for the computerized system 10, and/or one or more programs (e.g., computer program code and/or a computer program product) adapted to direct the processor 36 to preserve privacy according to the various embodiments discussed herein. The operating system and/or programs may be stored, for example, in a compressed, an uncompiled and/or an encrypted format, and may include computer program code. The instructions of the computer program code may be read into a main memory of the processor from a computer-readable medium other than the data storage structure 46, such as from the ROM 42 or from the RAM 40. While execution of sequences of instructions in the program causes the processor to perform the process steps described herein, hard-wired circuitry may be used in place of, or in combination with, software instructions for implementation of the processes of the present invention. Thus, embodiments of the present invention are not limited to any specific combination of hardware and software.

The program may also be implemented in programmable hardware devices such as field programmable gate arrays, programmable array logic, programmable logic devices or the like. Programs may also be implemented in software for execution by various types of computer processors. A program of executable code may, for instance, comprise one or more physical or logical blocks of computer instructions, which may, for instance, be organized as an object, procedure, process or function. Nevertheless, the executables of an identified program need not be physically located together, but may comprise separate instructions stored in different locations which, when joined logically together, comprise the program and achieve the stated purpose for the programs such as preserving privacy by executing the plurality of random operations. In an embodiment, an application of executable code may be a compilation of many instructions, and may even be distributed over several different code partitions or segments, among different programs, and across several devices.

The term “computer-readable medium” as used herein refers to any medium that provides or participates in providing instructions to the at least one processor 36 of the computerized system 10 (or any other processor of a device described herein) for execution. Such a medium may take many forms, including but not limited to, non-volatile media and volatile media. Non-volatile media include, for example, optical, magnetic, or opto-magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other medium from which a computer can read.

Various forms of computer readable media may be involved in carrying one or more sequences of one or more instructions to the at least one processor 36 (or any other processor of a device described herein) for execution. For example, the instructions may initially be borne on a magnetic disk of a remote computer (not shown). The remote computer can load the instructions into its dynamic memory and send the instructions over an Ethernet connection, cable line, or even telephone line using a modem. A communications device local to a computing device (e.g., a server) can receive the data on the respective communications line and place the data on a system bus for the at least one processor 36. The system bus carries the data to main memory, from which the at least one processor 36 retrieves and executes the instructions. The instructions received by main memory may optionally be stored in memory either before or after execution by the at least one processor 36. In addition, instructions may be received via a communication port as electrical, electromagnetic or optical signals, which are exemplary forms of wireless communications or data streams that carry various types of information.

In an embodiment, the computerized system 10 may be a home web proxy that monitors the user's usage of the World Wide Web 16 to determine typical usage patterns 26, shown in FIG. 1, and executes automated random operations or queries based on the user's usage patterns and a set of user configured web applications and/or sites from which to draw the lexicons (e.g. Google, Zeitgeist, Twitter, New York Times, etc.). Thus, the computerized system 10 may automatically mask searches and operations conducted by the user based on the user's own usage patterns using search or trending lexicons of interest to the World Wide Web community on websites and/or web applications selected by the user.

In an embodiment, the computerized system 10 may be a personal computer screen saver that executes automated random queries or operations when the personal computer is idle. In addition to initiating the operations or queries, the computerized system 10 may also select random links within the web applications to mimic the behavior of the user. In some embodiments, the computerized system 10 may run in the background of the personal computer so that computer performance is not degraded by the random operations generated by the computerized system.

The computerized system 10 enhances the user's ability to preserve privacy on the World Wide Web 16 by masking the actual operations executed by the user with random operations modeled after typical usage of the World Wide Web 16 by the user and/or typical usage of one or more specific web applications by the user.

The computerized system 10 also allows the user to tailor their network profile to a desired persona by selecting the lexicons, including search domains, and/or applications for the plurality of random operations.

Additionally, the computerized system 10 may run autonomously by monitoring the user's typical usage patterns 26, shown in FIG. 1, and by mining web application data 28 to define the frequency at which the user conducts operations through web applications and to define lexicons for the plurality of random operations.

Although this invention has been shown and described with respect to the detailed embodiments thereof, it will be understood by those skilled in the art that various changes in form and detail thereof may be made without departing from the spirit and the scope of the invention.

What is claimed is:

1. A computerized system for preserving privacy with at least one web application comprising:
a selection module adapted to select a plurality of lexicons; and
a privacy-preserving module adapted to execute a plurality of random operations through the at least one web application using the plurality of lexicons.

2. The computerized system according to claim 1, additionally comprising:
at least one data storage device storing the selection module and the privacy-preserving module; and
at least one computer processor configured to implement the selection module and the privacy-preserving module.

3. The computerized system according to claim 1, wherein the selection module includes a graphical user interface.

4. The computerized system according to claim 3, wherein the graphical user interface includes at least one input allowing selection of the plurality of lexicons.

5. The computerized system according to claim 1, additionally comprising a database for storing terminology from which the plurality of lexicons may be selected.

6. The computerized system according to claim 1, wherein the selection module includes a data-mining module adapted to determine a typical usage pattern of the at least one web application by a unique user.

7. The computerized system according to claim 6, wherein the privacy-preserving module executes the plurality of random operations using the plurality of lexicons and the typical usage pattern.

8. The computerized system according to claim 6, wherein the data-mining module is adapted to determine web application data including at least one of a typical usage of the web application by others and a current topic of interest on the at least one web application.

9. The computerized system according to claim 8, wherein the privacy-preserving module executes the plurality of random operations using the web application data.

10. A computerized method for preserving privacy comprising the steps of:
selecting, by a selection module executing on a computer processor, a plurality of lexicons; and
executing, by a privacy-preserving module executing on the computer processor, a plurality of random operations though at least one web application using the plurality of lexicons.

11. The computerized method according to claim 10, additionally comprising the step of:
determining, by the selection module executing on the computer processor, a typical usage pattern of the at least one web application by a user.

12. The computerized method according to claim 10, additionally comprising the step of:
generating, by the selection module executing on the computer processor, a graphical user interface.

13. The computerized method according to claim 10, wherein the step of selecting, by the selection module executing on the computer processor, a plurality of lexicons includes accessing stored terminology in a database.

14. The computerized method according to claim 13, wherein accessing the stored terminology in the database includes selecting the plurality of lexicons based on a specified discipline.

15. The computerized method according to claim 10, additionally comprising the step of:
determining, by the selection module executing on the computer processor, web application data including at least one of a typical usage of the web application by others and a current topic of interest on the at least one web application.

16. A non-transitory, tangible computer-readable medium storing instructions adapted to be executed by a computer processor to perform a method for preserving privacy with at least one web application, said method comprising the steps of:
selecting, by a selection module executing on a computer processor, a plurality of lexicons; and
executing, by a privacy-preserving module executing on the computer processor, a plurality of random operations though the at least one web application using the plurality of lexicons.

17. The non-transitory, tangible computer-readable medium of claim 16, wherein the method further comprises the step of:
determining, by the selection module executing on the computer processor, a typical usage pattern of the at least one web application by a user.

18. The non-transitory, tangible computer-readable medium of claim 16, wherein the step of selecting, by the selection module executing on the computer processor, a plurality of lexicons includes accessing stored terminology in a database.

19. The non-transitory, tangible computer-readable medium of claim 18, wherein accessing the stored terminology in the database includes selecting the plurality of lexicons based on a specified discipline.

20. The non-transitory, tangible computer-readable medium of claim 16, wherein the method further comprises the step of:
determining, by the selection module executing on the computer processor, web application data including at least one of a typical usage of the web application by others and a current topic of interest on the at least one web application.
